(19) United States
(12) Patent Application Publication
(10) Pub. No.: US 2026/0206994 A1
(43) Pub. Date: Jul. 23, 2026

(54) COOKING TRAY AND COOKING UTENSIL

(71) Applicant: Mor Designs Ltd., Taiwan (CN)

(72) Inventor: Hung-Mei LIEN, Taiwan (CN)

(21) Appl. No.: 19/071,070

(22) Filed: Mar. 5, 2025

(30) Foreign Application Priority Data
Jan. 20, 2025 (CN) 202520131859.X

(51) Int. Cl. A47J 27/022; A47J 27/00; H05B 3/02

(52) U.S. Cl. CPC A47J 27/022; A47J 27/002; H05B 3/02

(57) ABSTRACT

A cooking tray and a cooking utensil. The cooking tray includes a tray body and at least one stiffener arranged on the tray body. The tray body includes a base portion, the base portion has an upper surface and a lower surface opposite to each other. The stiffener is arranged on the lower surface, the stiffener is bent in a cross section perpendicular to its own extension direction, so that at least two connection ends are formed in a width direction of the stiffener. The at least two connection ends are connected to the lower surface, and also a heat conduction channel is formed between the stiffener and the base portion. The heat conduction channel has an opening connected to an external space.

### CROSS-REFERENCE TO RELATED APPLICATION

Pursuant to 35 U.S.C. § 119 and the Paris Convention, this application claims the benefit of Chinese Patent Application No. 202520131859.X filed on Jan. 20, 2025, the content of which is incorporated herein by reference.

### TECHNICAL FIELD

The present application relates to the field of kitchenware, more particularly a cooking tray and a cooking utensil.

### BACKGROUND

The statements provided herein are merely background information related to the present application, and do not necessarily constitute any prior arts. The cooking tray is a component installed on a grilling device or other cooking utensil, and

its function is to carry food and transfer heat to ensure that the food is evenly heated. The cooking tray is made of a thin metal plate which is easily deformed by heat during high-temperature cooking. Currently, to improve the structural stability of the cooking tray, one or more reinforcing plates are stacked at the bottom of the cooking tray, and the structural strength of the cooking tray is enhanced by the reinforcing plates, so that the cooking tray is not easily deformed by heat.

However, although the structural stability of the cooking tray can be improved by providing reinforcing plates, the thickness of the cooking tray in the area where the reinforcing plates are stacked will increase, thereby affecting the heat transfer efficiency and reducing the uniformity of the heat conduction of the cooking tray, which will lead to uneven heating of the food during the cooking process and affect the cooking effect.

### SUMMARY

One objective of the embodiments of the present application to provide cooking tray and a cooking utensil to solve the problem of poor uniformity of heat conduction caused by stiffeners arranged at the bottom of the cooking tray in the existing technologies.

To achieve the above-mentioned objective, a cooking tray is provided in accordance with a first aspect of the present application, which includes a tray body and at least one stiffener.

The tray body includes a base portion, the base portion has an upper surface and a lower surface that are opposite to each other.

The at least one stiffener is arranged on the lower surface. The stiffener bent in a cross section perpendicular to an extension direction of the stiffener, so that at least two connection ends are formed in a width direction of the stiffener. The at least two connection ends are connected to the lower surface, and also a heat conduction channel is formed between the stiffener and the base portion. The heat conduction channel has an opening connected to an external space.

In some embodiments, the opening includes at least one heat conduction hole provided on the stiffener.

In some embodiments, the heat conduction hole is arranged at a bend o the stiffener.

In some embodiments, multiple heat conduction holes are provided, and the multiple heat conduction holes are arranged at intervals along an extension direction of the heat conduction channel.

In some embodiments, multiple stiffeners are provided, and the multiple stiffeners are arranged at intervals on the lower surface.

In some embodiments, the tray body also includes a side wall portion arranged around a periphery of the base portion, and the base portion and the side wall portion are jointly arranged to form a receiving groove.

In some embodiments, the base portion is provided with an oil drain hole penetrating to the lower surface from the upper surface, and cross sections of the base portion perpendicular to the upper surface and passing through the oil drain hole are all flared at the oil drain hole 111.

In some embodiments, the base portion is provided with an oil drain groove on the upper surface, and the oil drain groove extends in a strip shape on the upper surface and is connected to a hole wall of the oil drain hole.

In some embodiments, the cooking tray also includes an oil guide member, the oil guide member is installed on the lower surface, and the oil guide member is provided with an oil guide channel connected to the oil drain hole.

In accordance with a second aspect of the present application, a cooking utensil is also provided, which includes a heating device and the cooking tray as described in any optional embodiment of the first aspect, and the heating device is configured to heat the cooking tray.

Compared with the existing technologies, the cooking tray and cooking utensil provided in the present application have at least the following beneficial effects: the cross section of the stiffener is formed in a bent shape, and both ends of the stiffener are connected to the lower surface of the tray body, so that a stable triangular support structure is formed between the stiffener and the tray body, which thus can strengthen the structural strength of the tray body and make the tray body less susceptible to thermal deformation. Moreover, a heat conduction channel is formed between the stiffener and the tray body, thereby, during the cooking process, external heat can enter the heat conduction channel through the opening of the heat conduction channel and be transferred to the tray body through the heat conduction channel, so that the tray body is evenly heated, which improves the structural strength of the tray body while also ensuring the uniformity of the heat conduction of the tray body, and thus the cooking effect of the food is improved.

### BRIEF DESCRIPTION OF THE DRAWINGS

In order to illustrate the technical solutions in the embodiments of the present application more clearly, the drawings that required for use in the description of the embodiments will be briefly introduced below. Obviously, the drawings in the following description are merely some embodiments of the present application. For ordinary technicians in this field, other drawings may also be obtained based on these drawings without exerting creative efforts.

FIG. 1 is a schematic structural diagram of a cooking tray in an embodiment of the present application;

FIG. 2 is a schematic structural diagram of the cooking tray from another perspective in the embodiment of the present application;

FIG. 3 is a partial cross-sectional view in A-A direction of FIG. 1;

FIG. 4 is a schematic structural diagram of a cooking tray in another embodiment of the present application;

FIG. 5 is a schematic structural diagram of the cooking tray from another perspective in the other embodiment of the present application;

FIG. 6 is a partial cross-sectional view in B-B direction of FIG. 4; and

FIG. 7 is a schematic structural diagram of a stiffener in an embodiment of the present application.

Reference signs in the drawings are listed as follows:
100—tray body; 110—base portion; 110a—upper surface; 110b—lower surface; 120—side wall; 130—connection part; 111—oil drain hole; 112—oil drain groove;
200—stiffener; 201—heat conduction channel; 202—heat conduction hole; and
300—oil guide member; 301—oil guide channel.

### DETAILED DESCRIPTION OF THE EMBODIMENTS

To illustrate the technical problems to be solved, technical solutions and beneficial effects of the present application more clearly, the present application is further described in detail in combination with the drawings and embodiments. It should be understood that the specific embodiments described herein are only used to explain the present application and are not intended to limit the present application.

It should be noted that when an element is referred to as “fixed on” or “arranged on” another element, it may be directly on the other element or indirectly on the other element. When an element is referred to as “connected to” another element, it may be directly connected to the other element or indirectly connected to the other element.

It should be understood that the orientation or position relationship indicated by the terms “length”, “width”, “upper”, “lower”, “front”, “rear”, “left”, “right”, “vertical”, “horizontal”, “top”, “bottom”, “inside”, “outside” and the like is based on the orientation or position relationship shown in the drawings, which is only for the convenience of describing the present application and simplifying the description, rather than indicating or implying that the device or element referred to must have a specific orientation, be constructed and operated in a specific orientation, and therefore should not be construed as a limitation on the present application.

In addition, the terms “first” and “second” are only used for descriptive purposes and cannot be understood as indicating or implying relative importance or implicitly indicating the number of technical features indicated. Therefore, the features defined as “first” and “second” may explicitly or implicitly include one or more of the features. In the description of the present application, the term “multiple” means two or more, unless otherwise clearly and specifically defined.

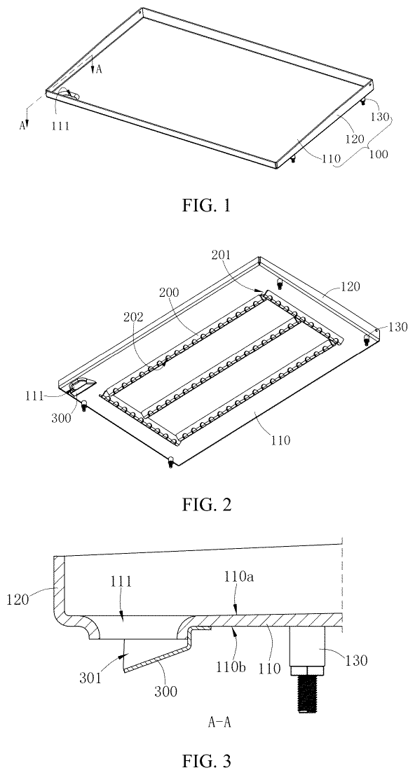

In a first aspect, an embodiment of the present application provides a cooking tray. As shown in FIGS. 1 to 7, the cooking tray includes a tray body 100 and at least one stiffener 200. The tray body 100 includes a base portion 110, and the base portion 110 has an upper surface 110a and a lower surface 110b that are opposite to each other. The stiffener 200 is arranged on the lower surface 110b and is bent in a section perpendicular to the extension direction of the stiffener, so that at least two connection ends are formed in the width direction of the stiffener 200. The at least two connection ends are connected to the lower surface 110b, and also a heat conduction channel 201 is formed between the stiffener 200 and the base portion 110. The heat conduction channel 201 has an opening connected to an external space.

The tray body 100 may be made of metal materials or non-metal materials that have good thermal conductivity, such as stainless steel, ceramics, etc. The shape of the tray body 100 may be designed to a rectangular, circular or any geometric shape according to actual cooking needs to be suitable for different cooking scenarios.

The base portion 110 is a plate-like structure having a certain area, which is the main supporting structure of the tray body 100. The base portion 110, when in use, is placed horizontally. The upper surface 110a of the base portion 110 is configured to carry ingredients, and the lower surface 110b is configured to contact the heating source.

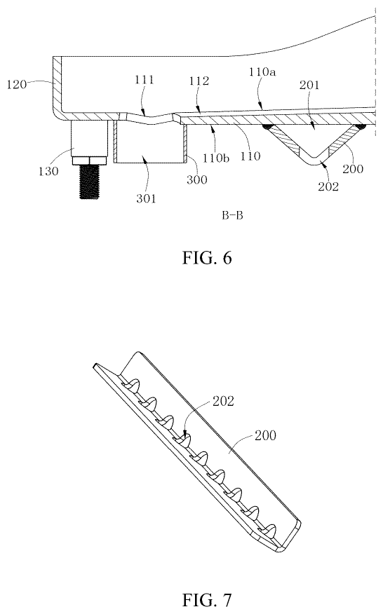

As shown in FIGS. 6 and 7, the stiffener 200 may be made of the same material as the tray body 100 to have better thermal conductivity and structural stability. The stiffener 200 has a long strip structure. The stiffener 200 can extend in a straight line or in a curved wave shape. The stiffener 200 is bent in the section perpendicular to its own extension direction. For example, the stiffener 200 is composed of two reinforcing plates at a certain angle. The two reinforcing plates may be integrally formed or may be separately formed and then fixedly connected, the cross-sectional shape of the stiffener 200 is V-shaped, and the two connection ends are formed in the width direction of the stiffener 200. The connection ends of the stiffener 200 may be fixed to the lower surface 110b of the base portion 110 by welding or riveting to ensure a firm connection between the stiffener 200 and the base portion 110. In addition, the cross-sectional shape of the stiffener 200 may also be U-shaped, W-shaped or other bent shapes to meet different design requirements.

By bending the stiffener 200, a triangular structure is formed between the stiffener 200 and the base portion 110, thereby the overall structural strength of the tray body 100 is enhanced, and thus, the tray body 100 is not susceptible to thermal deformation. In addition, the heat conduction channel 201 is formed between the bent stiffener 200 and the base portion 110, and the heat conduction channel 201 has an opening, thereby during a cooking process, heat can enter the heat conduction channel 201 through the opening and be transferred to the tray body 100 through the heat conduction channel 201, so that the tray body 100 is evenly heated, and the heating effect on the food is improved. In this way, the structural strength and thermal conductivity of the tray body 100 are both taken into account, to ensure uniform heat distribution during cooking, thereby the food is evenly heated.

In some embodiments, the opening may also include at least one heat conduction hole 202 provided on the stiffener 200. The heat conduction hole 202 may be a through hole of a circular, elliptical or other arbitrary shape, and an opening direction of the heat conduction hole 202 may be perpendicular to the base portion 110, so that heat can enter the heat conduction channel 201 more directly, accelerating the heat conduction efficiency.

The location of the heat conduction hole 202 may be arbitrary. For example, the heat conduction hole 202 may be arranged at the bend of the stiffener 200, that is, the heat conduction hole 202 simultaneously penetrates the two reinforcing plates of the stiffener 200, so as to ensure the structural strength of the stiffener while fully increasing the size of the heat conduction hole 202, so that heat can be more efficiently transferred to the heat conduction channel 201. It should be understood that the heat conduction hole 202 may also be provided on the two reinforcing plates that constitute the stiffener 200.

Multiple heat conduction holes 202 may be provided, and the multiple heat conduction holes 202 are arranged at intervals along the extension direction of the heat conduction channel 201 to form multiple vertical openings on the stiffener 200, so that the heat is evenly distributed in the heat conduction channel 201, which further improves the heat conduction efficiency.

In addition, as shown in FIGS. 2 and 5, an opening may be formed by each extension end of the stiffener 200 for heat to enter at both ends of the heat conduction channel 201, thereby the direction of heat entering the heat conduction channel 201 is increased, and thus the heat circulation effect in the heat conduction channel 201 is improved.

In some embodiments, multiple stiffeners 200 are provided, and the multiple stiffeners 200 are arranged at intervals on the lower surface 110b.

The multiple stiffeners 200 on the lower surface 110b may be arranged in a parallel, staggered or mesh-like manner, and may be arranged based on an area of the tray body 100 that is susceptible to thermal deformation, so as to improve the overall structural strength of the tray body 100 while optimizing the heat conduction path to ensure uniform heat distribution.

In an exemplary embodiment, as shown in FIG. 5, when the tray body 100 is rectangular in shape, the extension direction of some stiffeners 200 is parallel to the length direction of the tray body 100, and the extension direction of the remaining stiffeners 200 is parallel to the width direction of the tray body 100, so that the multiple stiffeners 200 are arranged in a grid. As shown in FIG. 2, in another embodiment, when the tray body 100 is rectangular in shape, the extension direction of the stiffener 200 is parallel to the length direction of the tray body 100, and the multiple stiffeners 200 are arranged at intervals along the width direction of the tray body 100.

In some embodiments, the tray body 100 also includes a side wall portion 120 arranged around a periphery of the base portion 110, and the base portion 110 and the side wall portion 120 are jointly arranged to form a receiving groove.

Particularly, the side wall portion 120 may be composed of multiple side plates, the number of side plates is the same as the number of the peripheral edges of the base portion 110 and in a one-to-one correspondence, the side plates may be perpendicular to the base portion 110, the bottom edge of each side plate is connected to the base portion 110, and two adjacent side plates are connected to each other, so that the multiple side plates constitute the side wall portion 120 surrounding the base portion 110. Herein, the side plates of the side wall portion 120 may be integrally formed with the base portion 110, for example, the entire tray body 100 may be manufactured by a stamping process. The side plates may also be manufactured separately and fixed to the edge of the base portion 110 by welding.

The receiving groove is formed by the side wall portion 120 and the upper surface 110a of the base portion 110. At this time, the upper surface 110a of the base portion 110 serves as the bottom surface of the receiving groove. When placing ingredients in the receiving groove during cooking, the ingredients or condiments can be prevented from sliding off the edge of the tray body 100, and also the oil droplets generated during cooking can be prevented from splashing out from the edge of the tray body 100.

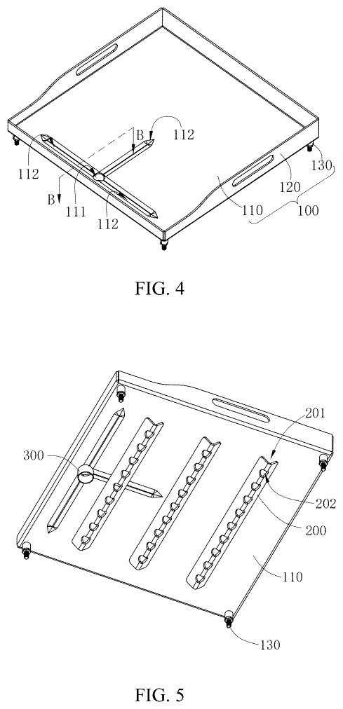

A handle structure may also be provided on the side wall portion 120. For example, as shown in FIG. 4, through holes are provided on the side wall portion 120 on both sides of the length direction of the base portion 110, so that the user can hold the side wall portion 120 at the through hole, which is convenient for the user's cooking operation.

In addition, the cooking tray may also include one or more connection parts 130. The one or more connection parts are provided on the lower surface 110b of the base portion 110, and are configured to fix the cooking tray in the cooking utensil. As shown in FIG. 2 and FIG. 5, the connection part 130 may be provided at each corner of the lower surface 110b of the base portion 110.

The connection part 130 may have an external thread, so that a nut may be configured to fix the connection part 130 to a corresponding position of the cooking utensil. The cooking tray is supported in the cooking utensil by using multiple connection parts 130 to ensure that the cooking tray is in a stable position during cooking. It also makes the installation and disassembly of the cooking tray in the cooking utensil simple and convenient, and after cooking, the cooking tray can be easily removed from the cooking utensil for cleaning and maintenance.

In some embodiments, the base portion 110 is provided with an oil drain hole 111 penetrating from the upper surface 110a to the lower surface 110b, and cross sections of the base portion 110 perpendicular to the upper surface 110a and passing through the oil drain hole 111 are all flared at the oil drain hole 111.

The oil drain hole 111 is a through hole that passes through the base portion 110 from top to bottom, and is configured to drain excess oils and fats during cooking. The shape of the oil drain hole 111 may be circular, elliptical or other geometric shapes, and the edge of the oil drain hole 111 may be rounded. On the one hand, the oils and fats can be discharged smoothly through the rounded corners, and it is not easy to flow back along the edge of the oil drain hole 111 to the upper surface 110a of the base portion 110. On the other hand, the sharpness of the oil drain hole 111 can be reduced to avoid accidental injuries during operation.

The upper surface 110a of the base portion 110 should be inclined relative to the horizontal plane, and the upper surface 110a is oriented toward the center of the oil drain hole 111, so that the oils and fats generated during cooking can naturally flow to the oil drain hole 111. It can be understood that the inclination direction of the upper surface 110a located at different orientations of the oil drain hole 111 are different, so that the cross sections of the base portion 110 perpendicular to the upper surface 110a and passing through the oil drain hole 111 are all flared at the oil drain hole 111, so that the oils and fats in each region of the base portion 110 can be gathered at the oil drain hole 111. In actual production, the entire base portion 110 may be inclined, and the thickness of each region of the base portion 110 may be kept consistent, thereby the difficulty of preparing the inclined upper surface 110a is reduced.

The location of the oil drain hole 111 on the base portion 110 may be arbitrary. As shown in FIG. 1, the oil drain hole 111 may be arranged close to one of the corners of the base portion 110. As shown in FIG. 4, the oil drain hole 111 may also be arranged in the middle of one side edge of the base portion 110. The upper surface 110a of the base portion 110 may be arranged to a corresponding inclined structure according to the different positions of the oil drain hole 111. In addition, the number of oil drain holes 111 may also be set to multiple, which will not be repeated in this embodiment.

By arranging the oil drain hole 111, the excess oils and fats generated during the cooking process is guided by the upper surface 110a of the base portion 110 and gathered at the oil drain hole 111, and discharged into the receiving groove through the oil drain hole 111, which avoids the accumulation of oil stains on the upper surface 110a and affect the taste of the food, and also facilitates the cleaning of the cooking tray after cooking.

In some embodiments, the base portion 110 is provided with an oil drain groove 112 on the upper surface 110a, and the oil drain groove 112 extends in a strip shape on the upper surface 110a and is connected to the hole wall of the oil drain hole 111.

The oil drain groove 112 is a groove structure provided on the upper surface 110a, and the oil drain groove 112 may be directly formed on the base portion 110 by a stamping process. The width and depth of the oil drain groove 112 may be adapted to the size of the oil drain hole 111, and the extension direction of the oil drain groove 112 may be parallel to the length direction or width direction of the base portion 110, or may be arranged obliquely relative to the length direction or width direction of the base portion 110. One side of the oil drain groove 112 is connected to the hole wall of the oil drain hole 111 so that the oil drain groove 112 is connected to the oil drain hole 111.

The number of oil drain grooves 112 can be set to multiple. For example, as shown in FIG. 4, the upper surface 110a of the base portion 110 is provided with three oil drain grooves 112, and the three oil drain grooves 112 are arranged around the circumference of the oil drain hole 111. The extension direction of two oil drain grooves 112 is parallel to the length direction of the base portion 110, and the extension direction of the other oil drain groove 112 is parallel to the width direction of the base portion 110.

Since the upper surface 110a is inclined toward the center of the oil drain hole 111, the oil drain groove 112 arranged on the upper surface 110a is also inclined toward the center of the oil drain hole 111. The oils and fats generated during the cooking process can first be gathered in the nearby oil drain groove 112, and then guided to the oil drain hole 111 through the oil drain groove 112, thereby the oil draining effect of the oils and fats can be improved.

In some embodiments, the cooking tray further includes an oil guide member 300, which is mounted on the lower surface 110b and is provided with an oil guide channel 301 connected to the oil drain hole 111.

Specifically, the oil guide member 300 is a shell structure mounted on the base portion 110, and the interior of the oil guide member 300 is hollow to form an oil guide channel 301, and the oil guide channel 301 should have an inlet and an outlet, the inlet may be arranged at the top of the oil guide member 300, and the outlet may be arranged at the bottom or the peripheral portion of the oil guide member 300. After the oil guide member 300 is mounted on the lower surface 110b of the base portion 110, the inlet of the oil guide channel 301 is connected to the oil drain hole 111, so that the oil drain hole 111 is connected to the oil guide channel 301.

The oil guide member 300 and the base portion 110 may be connected and fixed by means of snap connection, fastener connection, etc. For example, an annular flange is protruded from the lower surface 110b of the base portion 110 at the oil drain hole 111, and the shape of the inlet arranged on the top of the oil guide member 300 matches the outer contour shape of the annular flange, and the size of the inlet is slightly smaller than that of the outer contour of the annular flange, so that the inlet is sleeved by the annular flange to realize the connection between the oil guide member 300 and the base portion 110, meanwhile, the oil drain hole 111 and the oil guide channel 301 are connected.

The oil guide channel 301 can further guide and collect the discharged oils and fats to ensure that the oils and fats will not spill outside the cooking tray, and thus keep the cooking area clean. In addition, an oil collection structure such as an oil cup may be installed on one side of the outlet of the oil guide member 300 to collect the discharged oils and fats, which makes the handling of the oils and fats more convenient.

In a second aspect, the present application also provides a cooking utensil, including a heating device and the cooking tray in the embodiment of the first aspect, and the heating device is configured to heat the cooking tray.

Particularly, the cooking utensil may be a frying oven, a grill or other cooking utensils that use a cooking tray to cook ingredients. The heating device may be an electric heating element, a gas burner or an infrared heater, etc., and the position of the heating device may be arranged corresponding to the cooking tray. In use, the cooking tray may be installed above the heating device, and the heat generated by the heating device is transferred upward to the cooking tray, and the cooking tray is configured to transfer the heat to the ingredients to achieve cooking of the ingredients.

Herein, during the heating process of the cooking tray, the stiffeners arranged on the lower surface 110b of the tray body 100 can improve the structural strength of the tray body 100, so that the tray body 100 is not susceptible to thermal deformation. In the meantime, the heat conduction channel 201 and the multiple heat conduction holes 202 provided on the stiffeners can help the heat to be uniformly contacted with the tray body 100 for heat conduction, to improve the uniformity of the heating of the tray body 100, which enables the ingredients to be heated more uniformly during the cooking process, and thus improves the cooking effect of the ingredients.

The above description is only some optional embodiments of the present application and is not intended to limit the present application. Any modification, equivalent replacement and improvement made within the spirit and principle of the present application shall all be included within the protection scope of the present application.

What is claimed is:

1. A cooking tray, comprising:
a tray body, comprising a base portion, the base portion having an upper surface and a lower surface opposite to each other; and
at least one stiffener, arranged on the lower surface, wherein the at least one stiffener is bent in a cross section perpendicular to an extension direction of the at least one stiffener, so that at least two connection ends are formed in a width direction of the at least one stiffener, the at least two connection ends are connected to the lower surface, and a heat conduction channel is formed between the at least one stiffener and the base portion, and the heat conduction channel has an opening connected to an external space.

2. The cooking tray according to claim 1, wherein the opening comprises at lea one heat conduction hole provided on the at least one stiffener.

3. The cooking tray according to claim 2, wherein the at least one heat conduction hole is arranged at a bend of the at least one stiffener.

4. The cooking tray according to claim 2, wherein multiple heat conduction holes are provided, and the multiple heat conduction holes are arranged at intervals along an extension direction of the heat conduction channel.

5. The cooking tray according to claim 1, wherein multiple stiffeners are provided, and the multiple stiffeners are arranged at intervals on the lower surface.

6. The cooking tray according to claim 1, wherein the tray body further comprises a side wall portion arranged around a periphery of the base portion, and the base portion and the side wall portion are jointly arranged to form a receiving groove.

7. The cooking tray according to claim 6, wherein the base portion is provided with an oil drain hole penetrating to the lower surface from the upper surface, and cross sections of the base portion perpendicular to the upper surface and passing through the oil drain hole are all flared at the oil drain hole.

8. The cooking tray according to claim 7, wherein the base portion is provided with an oil drain groove on the upper surface, and the oil drain groove extends in a strip shape on the upper surface and is connected to a hole wall of the oil drain hole.

9. The cooking tray according to claim 7, wherein the cooking tray further comprises an oil guide member, the oil guide member is installed on the lower surface, and the oil guide member is provided with an oil guide channel connected to the oil drain hole.

10. A cooking utensil, comprising:
a cooking tray, comprising:
a tray body, comprising a base portion, the base portion having an upper surface and a lower surface opposite to each other; and
at least one stiffener, arranged on the lower surface, the at least one stiffener is bent in a cross section perpendicular to an extension direction of the at least one stiffener, so that at least two connection ends are formed in a width direction of the at least one stiffener, the at least two connection ends are connected to the lower surface, and a heat conduction channel is formed between the at least one stiffener and the base portion, and the heat conduction channel has an opening connected to an external space; and
a heating device, wherein the heating device is configured to heat the cooking tray.

11. The cooking utensil according to claim 10, wherein the opening comprises at least one heat conduction hole provided on the at least one stiffener.

12. The cooking utensil according to claim 11, wherein the at least one heat conduction hole is arranged at a bend of the at least one stiffener.

13. The cooking utensil according to claim 11, wherein multiple heat conduction holes are provided, and the multiple heat conduction holes are arranged at intervals along an extension direction of the heat conduction channel.

14. The cooking utensil according to claim 10, wherein multiple stiffeners are provided, and the multiple stiffeners are arranged at intervals on the lower surface.

15. The cooking utensil according to claim 10, wherein the tray body further comprises a side wall portion arranged around a periphery of the base portion, and the base portion and the side wall portion are jointly arranged to form a receiving groove.

16. The cooking utensil according to claim 15, wherein the base portion is provided with an oil drain hole penetrating to the lower surface from the upper surface, and cross sections of the base portion perpendicular to the upper surface and passing through the oil drain hole are all flared at the oil drain hole.

17. The cooking utensil according to claim 16, wherein the base portion is provided with an oil drain groove on the upper surface, and the oil drain groove extends in a strip shape on the upper surface and is connected to a hole wall of the oil drain hole.

18. The cooking utensil according to claim 16, wherein the cooking tray further comprises an oil guide member, the oil guide member is installed on the lower surface, and the oil guide member is provided with an oil guide channel connected to the oil drain hole.
